(19) United States
(12) Patent Application Publication
(10) Pub. No.: US 2026/0046039 A1
(43) Pub. Date: Feb. 12, 2026

(54) SIGNAL TRANSFER SYSTEMS, DEVICES AND METHODS

(71) Applicant: SKYWORKS SOLUTIONS, INC., Irvine, CA (US)

(72) Inventors: Amit KUMAR, Portland, OR (US); Thomas Jakob IRRGANG, Portland, OR (US)

(21) Appl. No.: 19/231,435

(22) Filed: Jun. 7, 2025

Related U.S. Application Data
(60) Provisional application No. 63/657,763, filed on Jun. 7, 2024.

(51) Int. Cl. H04B 14/06; H04L 27/20

(52) U.S. Cl. CPC H04B 14/06; H04L 27/2071

(57) ABSTRACT

A signal transfer architecture can include a transmit-side device configured to provide first and second signals from an original signal, and to transmit a combined signal including signals representative of the first and second signals. The architecture can further include a receive-side device configured to receive the combined signal and provide a reconstructed signal based on the received combined signal, such that the reconstructed signal is representative of the original signal. In some applications, the original signal can include a plurality of data frames each containing respective information, the first signal can include a compressed signal, and the second signal can include a delta signal representative of a difference between the original signal and the compressed signal.

### CROSS-REFERENCE TO RELATED APPLICATION(S)

This application claims priority to U.S. Provisional Application No. 63/657,763 filed Jun. 7, 2024, entitled SIGNAL TRANSFER SYSTEMS, DEVICES AND METHODS, the disclosure of which is hereby expressly incorporated by reference herein in its respective entirety.

### BACKGROUND

### Field

The present disclosure relates to communication signal transfer systems, devices and methods.

### Description of the Related Art

In communication systems, bandwidth is an important performance factor. In many situations, quality of signal transfer is at odds with bandwidth efficiency. For example, a signal transfer having high quality typically utilizes a high bandwidth usage. Conversely, a high efficiency bandwidth usage typically involves a signal transfer with lower quality.

### SUMMARY

In accordance with a number of implementations, the present disclosure relates to a signal transfer architecture that includes a transmit-side device configured to provide first and second signals from an original signal, and to transmit a combined signal including signals representative of the first and second signals. The signal transfer architecture further includes a receive-side device configured to receive the combined signal and provide a reconstructed signal based on the received combined signal, such that the reconstructed signal is representative of the original signal.

In some embodiments, the transmit-side device can include a transmitter and the receive-side device can include a receiver, with the transmitter and the receiver configured to allow the transmit and receive operations, respectively. In some embodiments, the transmitter and the receiver can be configured to support a wired link therebetween. In some embodiments, the transmitter and the receiver can be configured to support a wireless link therebetween. In some embodiments, the transmitter and the receiver can be configured to support either or both of a wireless link and a wired link therebetween.

In some embodiments, the transmitter can include a first signal processing circuit and a second signal processing circuit, with each being configured to receive the original signal, such that the first signal processing circuit provides the first signal and the second signal processing circuit provides the second signal.

In some embodiments, the first and second signal processing circuits can be configured to operate independently from each other.

In some embodiments, the second signal provided by the second signal processing circuit can depend on the first signal provided by the first signal processing circuit. In some embodiments, the second signal processing circuit can be configured to generate the second signal based on a difference between the original signal and the first signal provided by the first signal processing circuit. In some embodiments, the first signal processing circuit can include a signal compression encoder such that the first signal is a compressed signal, and the second signal processing circuit includes a delta engine configured to generate a delta signal representative of the difference between the original signal and the compressed signal provided by the first signal processing circuit.

In some embodiments, the original signal can include a plurality of data frames each containing respective information. The first signal can include a compressed signal, and the second signal can depend on the compressed signal. The second signal can include a delta signal representative of a difference between the original signal and the compressed signal. The delta signal can include one or more data frames, with each data frame including full or partial information contained in the corresponding data frame of the original signal.

In some embodiments, the received combined signal includes the compressed signal and the delta signal transmitted from the transmit-side device. The reconstructed signal can include an uncompressed signal obtained from the received compressed signal added with the received delta signal. The reconstructed signal can include all of the information associated with the original signal when each data frame of the received delta signal includes full information contained in the corresponding data frame of the original signal, such that information transfer is lossless.

In some embodiments, the first signal can include a high-priority signal, and the second signal can include a low priority signal. The high-priority signal can be a compressed signal to provide an efficient signal transfer throughput rate. The low-priority signal can include a delta signal representative of an error associated with generation of the compression signal, such that transfer of the delta signal utilizes a small bandwidth when compared to the transfer of the compressed signal.

In some embodiments, the received combined signal can include the compressed signal and the delta signal transmitted from the transmit-side device. The reconstructed signal can include an uncompressed signal obtained from the received compressed signal added with the received delta signal. The reconstructed signal can include all information associated with the original signal when the received delta signal includes full data frame(s), such that information transfer is lossless with the efficient signal transfer throughput rate being impacted with the small bandwidth increase.

In some implementations, the present disclosure relates to a method for transferring signals between a transmit side to a receive side. The method includes providing first and second signals from an original signal, and transmitting a combined signal that includes signals representative of the first and second signals. The method further includes receiving the combined signal, and forming a reconstructed signal based on the received combined signal, such that the reconstructed signal is representative of the original signal.

In some embodiments, the first signal can include a compressed signal, and the second signal can depend on the compressed signal. The second signal can include a delta signal representative of a difference between the original signal and the compressed signal.

In some implementations, the present disclosure relates to a transmit device that includes a signal processing circuit configured to generate first and second signals from an original signal, and a transmitter circuit configured to transmit a combined signal including signals representative of the first and second signals.

In some embodiments, the signal processing circuit can include a first signal processing circuit and a second signal processing circuit, with each configured to receive the original signal, such that the first signal processing circuit provides the first signal and the second signal processing circuit provides the second signal. The second signal provided by the second signal processing circuit can depend on the first signal provided by the first signal processing circuit. The second signal processing circuit can be configured to generate the second signal based on a difference between the original signal and the first signal provided by the first signal processing circuit. The first signal processing circuit can include a signal compression encoder such that the first signal is a compressed signal, and the second signal processing circuit can include a delta engine configured to generate a delta signal representative of the difference between the original signal and the compressed signal provided by the first signal processing circuit.

In some implementations, the present disclosure relates to a receive device that includes a receiver circuit configured to receive a combined signal including signals representative of first and second signals, and a signal processing circuit configured to generate a reconstructed signal based on the first and second signals.

In some embodiments, the first signal can be a compressed signal, and the second signal can be an uncompressed signal. The signal processing circuit can include a compression decoder configured to uncompress the compressed signal. The signal processing circuit can further include a summing circuit configured to add the uncompressed first signal and the uncompressed second signal to provide the reconstructed signal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1A depicts a signal transfer architecture where a high quality signal transfer involves a high bandwidth usage.

FIG. 1B shows a signal transfer architecture that can be a more specific example of the signal transfer architecture of FIG. 1A.

FIG. 2A depicts a signal transfer architecture where a signal transfer involves a lower bandwidth usage.

FIG. 2B shows a signal transfer architecture that can be a more specific example of the signal transfer architecture of FIG. 2A.

FIG. 3A depicts a signal transfer architecture where a signal transfer involves a bandwidth usage that can be less than the high bandwidth usage in the example of FIG. 1A and also provide a higher quality signal transfer than the compressed configuration of FIG. 2A.

FIG. 3B shows a signal transfer architecture that can be a more specific example of the signal transfer architecture of FIG. 3A.

FIG. 4 shows a signal transfer architecture that can be a more specific example of the signal transfer architecture of FIG. 3B.

### DETAILED DESCRIPTION OF SOME EMBODIMENTS

The headings provided herein, if any, are for convenience only and do not necessarily affect the scope or meaning of the claimed invention.

In communication systems, whether wired or wireless, bandwidth is an important performance factor. In many situations, quality of signal transfer is at odds with bandwidth efficiency. For example, a signal transfer having high quality typically utilizes a high bandwidth usage. Conversely, a high efficiency bandwidth usage typically involves a signal transfer with lower quality.

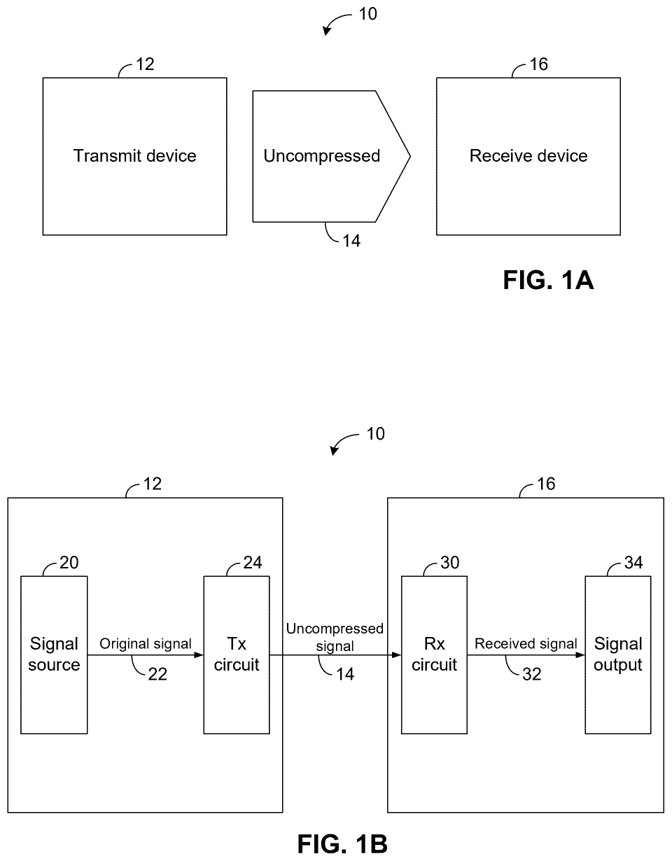

FIG. 1A depicts a signal transfer architecture 10 where a high quality signal transfer involves a high bandwidth usage. More particularly, a transmit device 12 is shown to transmit a high quality signal such as an uncompressed signal 14 to a receive device 16. In such a configuration, the uncompressed signal 14 is depicted as utilizing a high bandwidth usage.

FIG. 1B shows a signal transfer architecture 10 that can be a more specific example of the signal transfer architecture 10 of FIG. 1A. In FIG. 1B, a transmit device 12 is shown to include a signal source 20 that provides an original signal 22 to a transmit (Tx) circuit 24 configured to generate and transmit a high quality signal such as an uncompressed signal 14 that is representative of the original signal 22. It will be understood that the signal source 20 of the transmit device 12 can be implemented within the transmit device 12, external to the transmit device 12, or some combination thereof.

In FIG. 1B, a receive device 16 is shown to include a receive circuit 30 configured to receive the uncompressed signal 14 from the transmit device 12 and generate a corresponding received signal 32. Such a received signal can be provided to a signal output 34. It will be understood that the signal output 34 of the receive device 16 can be configured such that the received signal 32 is utilized within the receive device 16, external to the receive device 16, or some combination thereof.

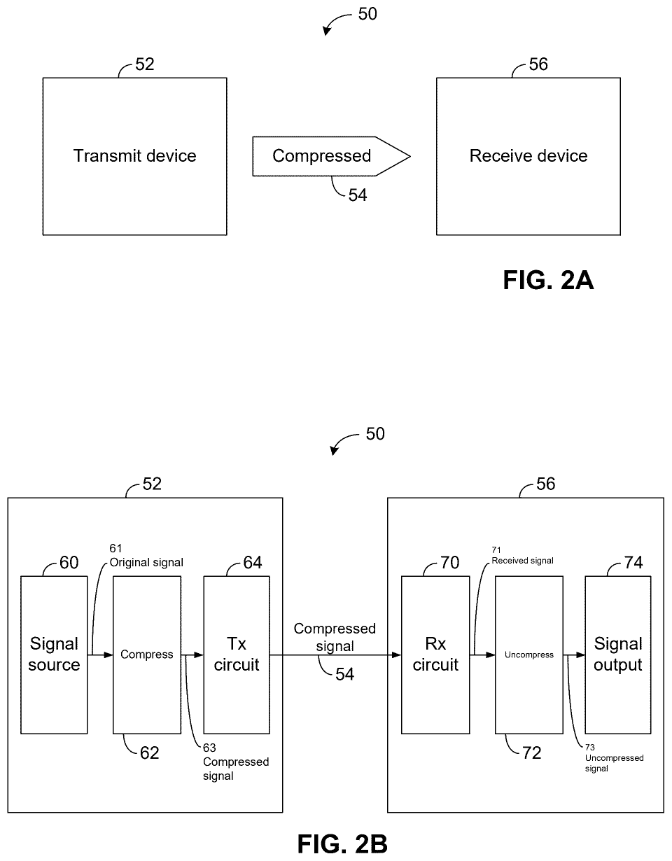

FIG. 2A depicts a signal transfer architecture 50 where a signal transfer involves a lower bandwidth usage. More particularly, a transmit device 52 is shown to transmit a compressed signal 54 to a receive device 56. In such a configuration, the compressed signal 54 is depicted as utilizing a lower bandwidth usage.

FIG. 2B shows a signal transfer architecture 50 that can be a more specific example of the signal transfer architecture 50 of FIG. 2A. In FIG. 2B, a transmit device 52 is shown to include a signal source 60 that provides an original signal 61 to a compression encoder 62 which in turn generates a corresponding compressed signal 63. The compressed signal 63 is then provided to a transmit (Tx) circuit 64 configured to generate and transmit a compressed signal 54 that is representative of the original signal 61. It will be understood that the signal source 60 of the transmit device 52 can be implemented within the transmit device 52, external to the transmit device 52, or some combination thereof.

In FIG. 2B, a receive device 56 is shown to include a receive circuit 70 configured to receive the compressed signal 54 from the transmit device 52 and generate a corresponding received signal 71. The received signal 71 is shown to be provided to a compression decoder 72 to generate an uncompressed signal 73. Such an uncompressed signal can be provided to a signal output 74. It will be understood that the signal output 74 of the receive device 56 can be configured such that the uncompressed signal 73 is utilized within the receive device 56, external to the receive device 56, or some combination thereof.

In some implementations, the present disclosure relates to a signal transfer architecture where a signal being transferred includes a first type and a second type. In terms of signal compression, the first type can be a compressed signal representative of a portion of an original signal, and the second type can include an uncompressed signal representative of another portion of the original signal or based on the original signal. Examples related to such a signal transfer architecture are provided herein.

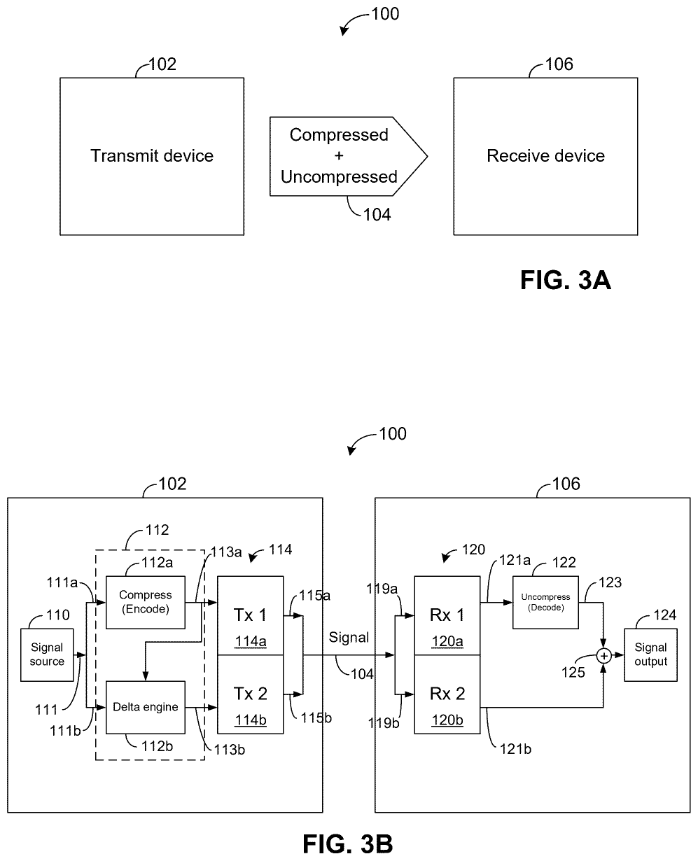

FIG. 3A depicts a signal transfer architecture 100 where a signal transfer involves a bandwidth usage that can be less than the high bandwidth usage in the example of FIG. 1A and also provide a higher quality signal transfer than the compressed configuration of FIG. 2A. In FIG. 3A, a transmit device 102 is shown to transmit a signal 104 that includes a compressed portion and an uncompressed portion to a receive device 106.

FIG. 3B shows a signal transfer architecture 100 that can be a more specific example of the signal transfer architecture 100 of FIG. 3A. In FIG. 3B, a transmit device 102 is shown to include a signal source 110 that provides an original signal 111 to a signal processing circuit 112 that generates a compressed signal 113a and an uncompressed signal 113b. Examples related to the signal processing circuit 112 are provided herein. It will be understood that the signal source 110 of the transmit device 102 can be implemented within the transmit device 102, external to the transmit device 102, or some combination thereof.

In FIG. 3B, the compressed and uncompressed signals 113a, 113b are shown to be provided to a transmit (Tx) circuit 114 configured to generate transmit signals 115a, 115b corresponding to the compressed and uncompressed signals 113a, 113b, respectively. In some embodiments, the transmit circuit 114 can include a first transmit circuit (Tx 1) 114a configured to generate the transmit signal 115a based on the compressed signal 113a, and a second transmit circuit (Tx 2) 114b configured to generate the transmit signal 115b based on the uncompressed signal 113b.

Referring to the example of FIG. 3B, the transmit signals 115a, 115b are depicted as being transmitted as a signal 104. In some embodiments, the signal 104 can be provided by combining the transmit signals 115a, 115b. It will be understood that such a signal (104) can be transmitted in a wired manner, in a wireless manner, or some combination thereof.

In FIG. 3B, a receive device 106 is shown to include a receive circuit 120 configured to receive the signal 104 from the transmit device 102 and generate received signals 119a, 119b corresponding to the transmit signals 115a, 115b. In some embodiments, the received signals 119a, 119b can be provided by splitting the signal 104.

FIG. 3B shows that in some embodiments, the receive circuit 120 can include a first receive circuit (Rx 1) 120a configured to generate a compressed received signal 121a based on the received signal 119a, and a second receive circuit (Rx 2) 120b configured to generate an uncompressed received signal 121b based on the received signal 119b. The compressed received signal 121a is shown to be provided to a compression decoder 122 to generate an uncompressed signal 123. Such an uncompressed signal (123) can be combined with the uncompressed received signal 121b (e.g., by a summing circuit 125) to provide a combined signal to a signal output 124. It will be understood that the signal output 124 of the receive device 106 can be configured such that the combined signal is utilized within the receive device 106, external to the receive device 106, or some combination thereof.

FIG. 3B shows that in some embodiments, the uncompressed signal 113b provided by the signal processing circuit 112 can include a signal representative of a difference between the original signal 111 and the compressed signal 113a. By way of an example, such a functionality can be provided by implementation of a compression encoder 112a and a delta engine 112b that are collectively depicted as parts of the signal processing circuit 112.

More particularly, and referring to FIG. 3B, the original signal 111 is shown to be provided to the compression encoder 112a as an input signal 111a, and the compression encoder 112a is shown to provide the compressed signal 113a as an output.

Referring to FIG. 3B, the delta engine 112b is shown to be provided with the original signal 111 as an input 111b, and the compressed signal 113a from the compression encoder 112a as another input. With such two inputs, the delta engine 112b can generate a delta signal as an output that is indicated as the uncompressed signal 113b in FIG. 3B. In some embodiments, the delta signal 113b can include some or all of a difference (delta) between information content of the original signal (111b) and information content of the compressed signal (113a). If the delta signal 113b includes all of the delta, any information lost in the compression encoder 112a can be fully recovered by the delta; thus, the delta signal 113b contains content that allows such a recovered information. Accordingly, the reconstructed signal at the signal output 124 of the receive device 124 can be substantially lossless in terms of information transfer.

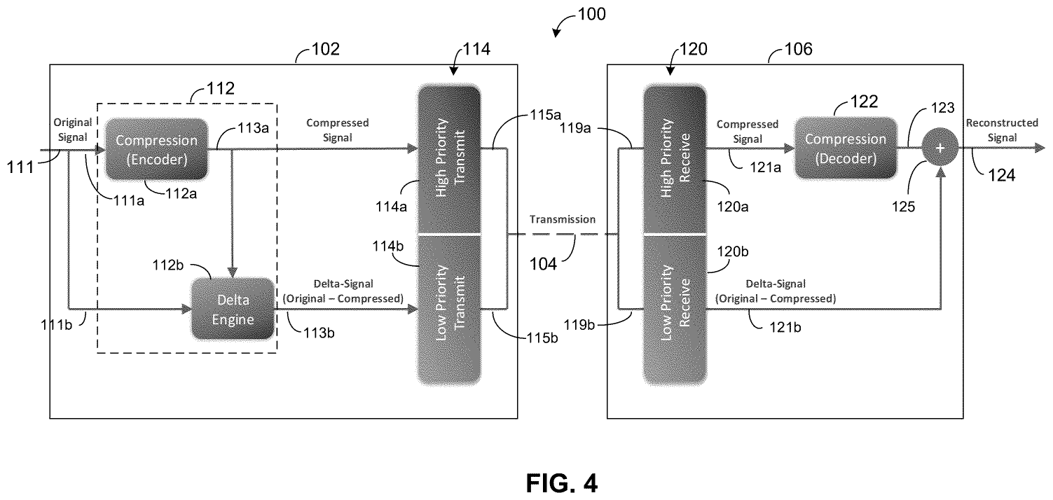

FIG. 4 shows a signal transfer architecture 100 that can be a more specific example of the signal transfer architecture 100 of FIG. 3B. FIG. 4 shows that in some embodiments, the first transmit circuit 114a can be operated as a high priority transmit circuit that transmits the compressed signal 113a on a priority basis. The second transmit circuit 114b can be operated as a low priority transmit circuit that transmits the delta signal 113b. Similarly, the first receive circuit 120a can be operated as a high priority receive circuit that receives the received signal 119a on a priority basis. The second receive circuit 120b can be operated as a low priority receive circuit that receives the received signal 119b.

In some embodiments, both of the high priority signal 115a and the low priority signal 115b can be transmitted to increase the quality of transmission. For example, error correction such as forward error correction and re-transmit process can be implemented.

As described herein, transmission of signals between a transmit device and a receive device can be implemented in a wireless manner, a wired manner, or some combination thereof. In the example of FIG. 4, transmission of the signal 104 can be implemented to be wireless or constrained-wired. For example, the constrained-wired operation can be implemented when available bandwidth is less than the peak data rate, and/or when data packet loss occurs or can occur.

In some embodiments, one or more features of the present disclosure can be implemented in a transmit device, a receive device, or some combination thereof. Such implementations can be advantageous in any applications where efficient signal transfers with features such as low latency and low or no loss transfer are desirable. As examples, electronic applications such as gaming control signal transfers, audio and/or video signal transfer can benefit from implementation of one or more features as described herein.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to. ” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration. ” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A signal transfer architecture comprising:
a transmit-side device configured to provide first and second signals from an original signal, and to transmit a combined signal including signals representative of the first and second signals; and
a receive-side device configured to receive the combined signal and provide a reconstructed signal based on the received combined signal, such that the reconstructed signal is representative of the original signal.

2. The signal transfer architecture of claim 1 wherein the transmit-side device includes a transmitter and the receive-side device includes a receiver, the transmitter and the receiver configured to allow the transmit and receive operations, respectively.

3. The signal transfer architecture of claim 2 wherein the transmitter and the receiver are configured to support a wired link therebetween.

4. The signal transfer architecture of claim 2 wherein the transmitter and the receiver are configured to support a wireless link therebetween.

5. The signal transfer architecture of claim 2 wherein the transmitter and the receiver are configured to support either or both of a wireless link and a wired link therebetween.

6. The signal transfer architecture of claim 2 wherein the transmitter includes a first signal processing circuit and a second signal processing circuit, each configured to receive the original signal, such that the first signal processing circuit provides the first signal and the second signal processing circuit provides the second signal.

7. The signal transfer architecture of claim 6 wherein the first and second signal processing circuits operate independently from each other.

8. The signal transfer architecture of claim 6 wherein the second signal provided by the second signal processing circuit depends on the first signal provided by the first signal processing circuit.

9. The signal transfer architecture of claim 8 wherein the second signal processing circuit is configured to generate the second signal based on a difference between the original signal and the first signal provided by the first signal processing circuit.

10. The signal transfer architecture of claim 9 wherein the first signal processing circuit includes a signal compression encoder such that the first signal is a compressed signal, and the second signal processing circuit includes a delta engine configured to generate a delta signal representative of the difference between the original signal and the compressed signal provided by the first signal processing circuit.

11. The signal transfer architecture of claim 1 wherein the original signal includes a plurality of data frames each containing respective information.

12. The signal transfer architecture of claim 11 wherein the first signal includes a compressed signal, and the second signal depends on the compressed signal.

13. The signal transfer architecture of claim 12 wherein the second signal includes a delta signal representative of a difference between the original signal and the compressed signal.

14. The signal transfer architecture of claim 13 wherein the delta signal includes one or more data frames, each data frame including full or partial information contained in the corresponding data frame of the original signal.

15. The signal transfer architecture of claim 14 wherein the received combined signal includes the compressed signal and the delta signal transmitted from the transmit-side device.

16. The signal transfer architecture of claim 15 wherein the reconstructed signal includes an uncompressed signal obtained from the received compressed signal added with the received delta signal.

17. The signal transfer architecture of claim 16 wherein the reconstructed signal includes all of the information associated with the original signal when each data frame of the received delta signal includes full information contained in the corresponding data frame of the original signal, such that information transfer is lossless.

18. The signal transfer architecture of claim 1 wherein the first signal includes a high-priority signal, and the second signal includes a low priority signal.

19. The signal transfer architecture of claim 18 wherein the high-priority signal is a compressed signal to provide an efficient signal transfer throughput rate.

20. The signal transfer architecture of claim 19 wherein the low-priority signal includes a delta signal representative of an error associated with generation of the compression signal, such that transfer of the delta signal utilizes a small bandwidth when compared to the transfer of the compressed signal.

21. The signal transfer architecture of claim 20 wherein the received combined signal includes the compressed signal and the delta signal transmitted from the transmit-side device.

22. The signal transfer architecture of claim 21 wherein the reconstructed signal includes an uncompressed signal obtained from the received compressed signal added with the received delta signal.

23. The signal transfer architecture of claim 22 wherein the reconstructed signal includes all information associated with the original signal when the received delta signal includes full data frame(s), such that information transfer is lossless with the efficient signal transfer throughput rate being impacted with the small bandwidth increase.

24. A method for transferring signals between a transmit side to a receive side, the method comprising:
providing first and second signals from an original signal;
transmitting a combined signal that includes signals representative of the first and second signals;
receiving the combined signal; and
forming a reconstructed signal based on the received combined signal, such that the reconstructed signal is representative of the original signal.

25. The method of claim 24 wherein the first signal includes a compressed signal, and the second signal depends on the compressed signal.

26. The method of claim 25 wherein the second signal includes a delta signal representative of a difference between the original signal and the compressed signal.

27. A transmit device comprising:
a signal processing circuit configured to generate first and second signals from an original signal; and
a transmitter circuit configured to transmit a combined signal including signals representative of the first and second signals.

28. The transmit device of claim 27 wherein the signal processing circuit includes a first signal processing circuit and a second signal processing circuit, each configured to receive the original signal, such that the first signal processing circuit provides the first signal and the second signal processing circuit provides the second signal.

29. The transmit device of claim 28 wherein the second signal provided by the second signal processing circuit depends on the first signal provided by the first signal processing circuit.

30. The transmit device of claim 29 wherein the second signal processing circuit is configured to generate the second signal based on a difference between the original signal and the first signal provided by the first signal processing circuit.

31. The transmit device of claim 30 wherein the first signal processing circuit includes a signal compression encoder such that the first signal is a compressed signal, and the second signal processing circuit includes a delta engine configured to generate a delta signal representative of the difference between the original signal and the compressed signal provided by the first signal processing circuit.

32. A receive device comprising:
a receiver circuit configured to receive a combined signal including signals representative of first and second signals; and
a signal processing circuit configured to generate a reconstructed signal based on the first and second signals.

33. The transmit device of claim 32 wherein the first signal is a compressed signal, and the second signal is an uncompressed signal.

34. The transmit device of claim 33 wherein the signal processing circuit includes a compression decoder configured to uncompress the compressed signal.

35. The transmit device of claim 34 wherein the signal processing circuit further includes a summing circuit configured to add the uncompressed first signal and the uncompressed second signal to provide the reconstructed signal.
